(19) United States
(12) Patent Application Publication
(10) Pub. No.: US 2012/0258367 A1
(43) Pub. Date: Oct. 11, 2012

(54) NANOCOMPOSITE MATERIAL, METHOD FOR PREPARING THE SAME, AND ENERGY STORAGE DEVICE INCLUDING THE SAME

(75) Inventors: Hyun Chul Jung, Gyeonggi-do (KR); Kwang Bum Kim, Seoul (KR); Bae Kyun Kim, Gyeonggi-do (KR); Seong Min Bak, Gyeonggi-do (KR)

(73) Assignees: INDUSTRY-ACADEMIC COORPERATION FOUNDATION, YONSEI UNIVERSITY; SAMSUNG ELECTRO-MECHANICS CO., LTD.

(21) Appl. No.: 13/358,283

(22) Filed: Jan. 25, 2012

(30) Foreign Application Priority Data
Apr. 6, 2011 (KR) 10-2011-0031715

(51) Int. Cl. H01M 4/131; H01G 9/155; H01B 1/04; B05D 5/12; B82Y 40/00; B82Y 30/00

(52) U.S. Cl. 429/231.1; 252/506; 427/79; 427/590; 361/502; 977/734; 977/773; 977/890; 977/948

(57) ABSTRACT

The present invention relates to a nanocomposite material including graphene and a lithium-containing metal oxide on a surface of the graphene, a method for preparing the same, and an energy storage device including the same as an electrode material.

According to the present invention, the nanocomposite material, in which the nano-sized lithium-containing metal oxide with high crystallinity is combined with the graphene with high specific surface area and high electrical conductivity, has an effect of achieving excellent high efficiency charge and discharge characteristics of energy storage devices such as an ultra-high capacity capacitor with high power and high energy density and a lithium secondary battery with high energy density.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0031715, entitled filed Apr. 6, 2011, which is hereby incorporated by reference in its entirety into this application.

### BACKGROUND OF THE INVENTION

1. Field of the Invention

The present invention relates to a nanocomposite material, a method for preparing the same, and an energy storage device including the same, and more particularly, to a nanocomposite material for electrode preparation with high energy density and high power characteristics, a method for preparing the same, and an energy storage device including the same.

2. Description of the Related Art

An ultra-high capacity capacitor is referred to as a supercapacitor or an ultracapacitor.

The ultra-high capacity capacitor is a long-life and high power electrical energy storage device which instantaneously or continuously discharges and supplies high current for several seconds or minutes after instantaneously charging much electrical energy.

According to international environmental policies such as the climatic change convention, green cars, and green home and a forward-looking distribution outlook for green technology, ultra-high capacity capacitor technology that efficiently stores electrical energy is designated as disruptive technology, which can dramatically change existing industries, with lithium secondary battery technology.

This ultra-high capacity capacitor has been limitedly used as a memory backup power supply of consumer electronics and mobile communication devices so far, but its applications have been extended to various fields such as IT, ubiquitous, transportation, machinery, and smart grid in recent times according to improvement of its energy density characteristics.

A current commercial ultra-high capacity capacitor is an electric double layer capacitor (EDLC) which uses activated carbon with high specific surface area as an electrode material. The EDLC stores charges on the interface between activated carbon and electrolyte by using electrosorption/electrodesorption reactions of cations or anions in the electrolyte. At this time, specific capacitance, which represents charge storage capacity, is reported as ˜150 F/g.

In case of a high power ultra-high capacity capacitor, improvement of energy density through development of a high specific capacitance electrode material has been demanded.

The energy density of the ultra-high capacity capacitor is linear-functionally proportional to the specific capacitance of the electrode material, and research and development of the electrode material with specific capacitance of greater than 300 F/g is required to extend applications of the ultra-high capacity capacitor to ubiquitous, transportation, machinery, and smart grid industries.

The key point is the concept of nanocomposite material that two or more charge storage reactions act in one electrode material and implement a synergy effect by mixing carbon with electric double layer charge storage characteristics and transition metal oxides with charge storage characteristics by Faradaic reaction to increase specific capacitance of an electrode material.

Meanwhile, a lithium secondary battery has high energy density, but has low power characteristics. Accordingly, research and development for improvement of power characteristics and minimization of loss of energy density have been tried through application of a nanoelectrode material.

In case of a high power ultra-high capacity capacitor, improvement of energy density is required. In case of a lithium secondary battery with high energy density, improvement of power characteristics is required.

Meanwhile, in case of LiMn₂O₄, that is, an electrode material of a non-aqueous capacitor and a lithium ion battery, since it is a low-cost material with high specific capacitance, there have been many researches for applications of the electrode material. The most used method of preparing LiMn₂O₄ is a method of mixing lithium salt and manganese salt in a solid state and heat-treating the mixture at a high temperature (above 500° C.), and LiMn₂O₄ is prepared and used in a micrometer-sized powder state.

However, there is a need for development of a nano-sized lithium manganese oxide in order to maximize electrochemical utilization of a metal oxide. Accordingly, there have been many researches related to synthesis of the nano-sized lithium manganese oxide. However, since a considerable number of researches have difficulties in achieving high electrochemical utilization of nano-sized particles due to agglomeration between the nano-sized lithium manganese oxides and in securing high crystallinity during synthesis of the nanoparticles, significant improvement in electrochemical characteristics has not been made yet.

### SUMMARY OF THE INVENTION

The present invention has been invented in order to overcome the above-described problems and it is, therefore, an object of the present invention to provide a nanocomposite material for electrode preparation with high energy density and high power characteristics.

It is another object of the present invention to provide a method for preparing a nanocomposite material with nano-sized crystallinity.

It is still another object of the present invention to provide an energy storage device including a nanocomposite material as an electrode material.

In accordance with one aspect of the present invention to achieve the object, there is provided a nanocomposite material including: graphene; and a lithium-containing metal oxide on a surface of the graphene.

The graphene may have a plate shape formed by sp2 bonds of carbon atoms, and it may be preferred that the graphene has a thickness of 0.34 to 4.0 nm.

The graphene may have a two-dimensional electron conduction path.

The lithium-containing metal oxide may be represented as the following formula 1.

LixMyOz Formula 1

In the above formula, M is at least one selected from the group consisting of manganese, nickel, magnesium, cobalt, and copper, x is 0.01 to 4.0, y is 0.9 to 5.0, and z is 1.9 to 12.0.

The lithium-containing metal oxide on the surface of the graphene may have a size less than 100 nm.

The nanocomposite material may have a three-dimensional structure in which the lithium-containing metal oxide is laminated on the graphene.

Further, in accordance with another aspect of the present invention to achieve the object, there is provided a method for preparing a nanocomposite material including: preparing a metal oxide/graphene precursor by reaction of a metal oxide and graphene; and forming a lithium-containing metal oxide on a surface of the graphene by reaction of the metal oxide/graphene precursor and a lithium ion solution.

The metal oxide in the metal oxide/graphene precursor may be maintained in a metal ion state by hydrolysis reaction.

The hydrolyzed metal ion may be reduced to the lithium-containing metal oxide from the lithium ion solution and deposited on the surface of the graphene.

The metal oxide may include at least one metal selected from the group consisting of manganese, nickel, magnesium, cobalt, and copper.

The graphene may be in the form of powder or aqueous dispersion.

The metal oxide/graphene precursor may be prepared at a temperature of 20 to 400° C.

It may be preferred that the metal oxide and the graphene are mixed at a weight ratio of 1:99 to 99:1.

The lithium ion may be a monovalent lithium ion.

The lithium ion solution may be at least one selected from the group consisting of hydrates, nitrides, chlorides, and oxides containing lithium ions.

The lithium-containing metal oxide may be formed on the surface of the graphene at a temperate of 20 to 500° C.

It may be preferred that the lithium-containing metal oxide is formed on the surface of the graphene by a microwave hydrothermal reactor.

Further, in accordance with still another aspect of the present invention to achieve the object, there is provided an energy storage device including a nanocomposite material, which includes graphene and a lithium-containing metal oxide on a surface of the graphene, as an electrode material.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flow chart showing a method for preparing a nanocomposite material in accordance with the present invention;

FIG. 2 is a TEM picture of graphene coated with a lithium manganese oxide in accordance with an embodiment of the present invention;

FIG. 3 is a graph showing discharge curves at various C-rates of a lithium manganese oxide/graphene composite material in accordance with an embodiment of the present invention;

FIG. 4 is a graph showing C-rate dependence of specific capacitance of the lithium manganese oxide/graphene composite material in accordance with an embodiment of the present invention; and

FIG. 5 is a graph showing life characteristics of the lithium manganese oxide/graphene composite material in accordance with an embodiment of the present invention.

### DETAILED DESCRIPTION OF THE PREFERABLE EMBODIMENTS

Hereinafter, the present invention will be described in detail.

The present invention relates to a nanocomposite material, a method for preparing the same, and an energy storage device including the same as an electrode material.

A nanocomposite material in accordance with the present invention has a structure including graphene and a lithium-containing metal oxide on a surface of the graphene.

The graphene has a plate shape formed by sp2 bonds of carbon atoms and is a two-dimensional carbon nanosheet with a thickness corresponding to one layer of atoms, that is, about 0.34 to 4.0 nm.

When comparing with existing carbon materials, that is, carbon nanotube and carbon nanofiber, the graphene has excellent characteristics in terms of chemical/structural stabilities, electrical conductivity (>100 S/m), and specific surface area (2600 m²/g).

The carbon nanosheet type graphene has a two-dimensional electron conduction path. Therefore, the graphene may be ideal as an electrode material of various energy storage devices due to its high electrical conductivity and very high specific surface area.

Therefore, synthesis and application technologies of graphene-based materials may be evaluated as breakthrough technologies for overcoming limitations of the existing carbon materials due to these high physical and chemical characteristics.

The lithium-containing metal oxide formed on the surface of the graphene may be represented as the following formula 1.

LixMyOz Formula 1

In the above formula, M is at least one selected from the group consisting of manganese, nickel, magnesium, cobalt, and copper, x is 0.01 to 4.0, y is 0.9 to 5.0, and z is 1.9 to 12.0.

Specifically, all kinds of lithium-containing materials, which are used as electrode active materials of a lithium secondary battery and a lithium ion capacitor, can be included without limitation.

Further, it is preferred that the lithium-containing material is a lithium-containing metal oxide for which one or more various metals selected from the group consisting of manganese, nickel, magnesium, cobalt, and copper are substituted.

It is preferred that the lithium-containing metal oxide on the surface of the graphene has a size less than 100 nm so that a diffusion distance of lithium in the metal oxide is reduced to improve high rate charge and discharge characteristics.

Therefore, the nanocomposite material in accordance with the present invention has a three-dimensional structure in which the lithium-containing metal oxide is laminated on the graphene. The graphene of the present invention has a two-dimensional structure, and the nanocomposite material in accordance with the present invention has a three-dimensional structure by laminating the lithium-containing metal oxide on the surface of the graphene.

Due to these structural characteristics, when the nanocomposite material is used as an electrode material of an energy storage device including ultra-high capacity capacitors such as a lithium secondary battery and a lithium ion capacitor, it is possible to achieve high efficiency discharge characteristics, life characteristics, and specific capacitance.

Hereinafter, a method for preparing a nanocomposite material in accordance with the present invention will be described in detail.

First, the first step prepares a metal oxide/graphene precursor by reaction of a metal oxide and graphene.

The metal oxide represents a metal oxide included in a lithium-containing metal oxide in accordance with the present invention and may include at least one metal selected from the group consisting of manganese, nickel, magnesium, cobalt, and copper.

The above metal is substituted for lithium to form various types of lithium-containing metal oxide structures. For example, various types of lithium-containing metal oxides and lithium-containing metal composite oxides such as a lithium manganese oxide (LiMn₂O₄), a lithium cobalt oxide (LiCoO₂), a lithium nickel oxide (LiNiO₂), and a lithium manganese cobalt composite oxide (Li(NiMnCo)O₂) may be included.

For example, when the metal is manganese (Mn), the metal oxide may be KMnO₄ or NaMnO₄, that is, a Me solution, or K₂MnO₄, that is, a Mn⁶⁺ solution.

The graphene in accordance with the present invention may be used in the form of powder or aqueous dispersion in which powder is dispersed in water.

The metal oxide/graphene precursor may be prepared by reaction of the metal oxide and the graphene at a temperature of about 20 to 400° C. If the reduction reaction temperature is too low, there may be a problem that salt is deposited due to too slow reduction reaction or reduction in solubility. If the reduction reaction temperature is too high, there may be a problem that a transition metal oxide is deposited on the solution.

Further, it is advantageous that the metal oxide and the graphene are mixed at a weight ratio of 1:99 to 99:1 to control particle formation, size, and composition of a metal oxide of a lithium metal oxide/graphene metal material of the next step and improve high rate charge and discharge characteristics when applied as an electrode material.

The second step forms a lithium-containing metal oxide on a surface of the graphene by mixing a lithium ion solution in the metal oxide/graphene precursor.

The lithium ion may be a monovalent lithium ion.

The lithium ion solution may be at least one selected from the group consisting of hydrates, nitrides, chlorides, and oxides containing lithium ions.

The metal oxide may be formed on the surface of the graphene at a temperature of 20 to 500° C.

It is preferred that the metal oxide may be formed on the surface of the graphene by a microwave hydrothermal reactor.

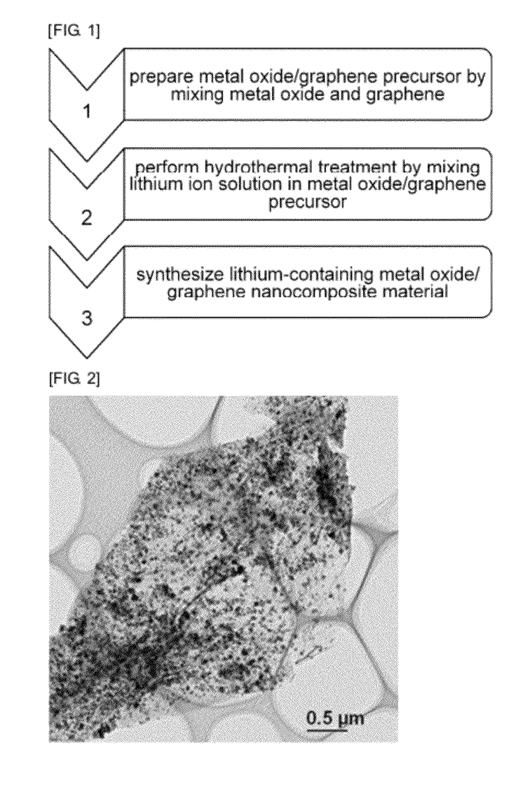

The following FIG. 1 is a flow chart showing a process of preparing a nanocomposite material in accordance with the present invention, and each step will be described in detail with reference to this.

First, in the present invention, a lithium manganese oxide is described as an example of a lithium-containing metal oxide formed on a surface of graphene.

As the first step, a manganese oxide/graphene precursor is prepared by reaction of a manganese ion solution and the graphene at a predetermined temperature. In the precursor, a manganese oxide (MnO₂) is present on the graphene as it is.

Next, a nanocomposite material in which a lithium manganese oxide is formed on the surface of the graphene, can be obtained by mixing the manganese oxide/graphene precursor in a lithium ion solution and maintaining the mixture at a predetermined temperature.

In this step, the manganese oxide (MnO₂) in the manganese oxide/graphene precursor is present in a Mn⁴⁺ ion state by hydrolysis reaction, reduced to the lithium manganese oxide again by the lithium ion solution, and deposited on the surface of the graphene.

A process of forming LiMn₂O₄ nanoparticles on the graphene by reaction of the manganese oxide/graphene precursor in the lithium ion solution is as the following reaction formula 1.

MnO₂+2H₂O->Mn⁴⁺+4OH⁻

Mn⁴⁺+4Li++36OH⁻->4LiMn₂O₄+18H₂O+O₂ (Reaction Formula 1)

According to the reaction formula 1, MnO2 on the manganese oxide/graphene used as a precursor is present in a Mn⁴⁺ ion state by hydrolysis reaction, and a Mn⁴⁺ ion is reduced to LiMn₂O₄ by LiOH and deposited and distributed on the graphene.

The above reaction is an endothermic reaction which requires heat supply, and in the present invention, heat can be supplied by a microwave hydrothermal reactor.

Meanwhile, the present invention provides an energy storage device including a nanocomposite material, which includes graphene and a lithium-containing metal oxide on a surface of the graphene, as an electrode material.

When the nanocomposite material of the present invention is used as an electrode material, the nanocomposite material may include a binder, a conductive agent, and other additives included in the common electrode materials, and types thereof are not particularly limited.

The energy storage device may be a lithium secondary battery, an electric double layer capacitor, an ultra-high capacity capacitor, and so on, but all kinds of energy storage devices are possible without being limited thereto.

Hereinafter, preferred embodiments of the present invention will be described with reference to the accompanying drawings. The embodiments of the present invention are provided to more completely explain the present invention to those skilled in the art. The present invention should not be construed as limited to the embodiments set forth herein and may be embodied in different forms. Rather, these embodiments are provided so that this disclosure will be more thorough and complete and will fully convey the spirit of the invention to those skilled in the art.

### First Embodiment

### Preparation of Lithium Manganese Oxide/Graphene Nanocomposite Material

0.1 g of graphene in the form of powder and 200 mL of a 0.03M KMnO₄ solution are mixed and stirred at 70° C. for 8 hours. A manganese oxide/graphene precursor is prepared by collecting the prepared reaction product through centrifugation, cleaning the reaction product several times with distilled water to completely remove ions remaining in the solution, and drying the reaction product in an oven at 80° C. for 24 hours.

0.3 g of the manganese oxide/graphene precursor and 40 mL of a 0.1M LiOH solution are mixed, put in a microwave hydrothermal reaction vessel, and react at 200° C. for 30 minutes by using microwaves. A lithium manganese oxide/graphene nanocomposte material is obtained by collecting the prepared reaction product through a centrifugal separator, cleaning the reaction product several times with distilled water, and drying the reaction product in an oven at 100° C. for 24 hours.

### Second Embodiment

### Electrode Preparation

Slurry is prepared by mixing a lithium manganese oxide/graphene nanocomposite material obtained according to the first embodiment, a conductive agent, and a binder at a weight ratio of 85:10:5 to use the lithium manganese oxide/graphene nanocomposite material as an electrode material.

At this time, the conductive agent is acetylene black, and the binder is PVDF melt in N-methyl-2-pyrrolidone (NMP). After the conductive agent is added to the lithium manganese oxide/graphene nanocomposite material powder and uniformly mixed again by a ball mill, the binder and the NMP are added and uniformly mixed again by the ball mill.

The uniform slurry prepared by the above method is applied on a titanium (Ti) foil current collector to prepare an electrode and dried in an oven at 100° C. for 12 hours.

### First Experimental Example

### Checking of Structure of Nanocomposite Material

A structure of a nanocomposite material obtained according to the first embodiment is measured by a transmission electron microscope (TEM), and measurement results are shown in the following FIG. 2.

As in the following FIG. 2, it is possible to check that a lithium manganese oxide is uniformly coated on a surface of graphene with a nanocrystalline structure. Further, it is possible to check that the lithium manganese oxide is formed on the surface of the graphene with a very fine nanoparticle size less than 10 nm. Therefore, it is possible to check that the nanocomposite material has a three-dimensional structure in which the lithium manganese oxide with a fine nanoparticle size is formed on the graphene with a two-dimensional structure.

### Second Experimental Example

### Measurement of Battery Characteristics of Nanocomposite Material

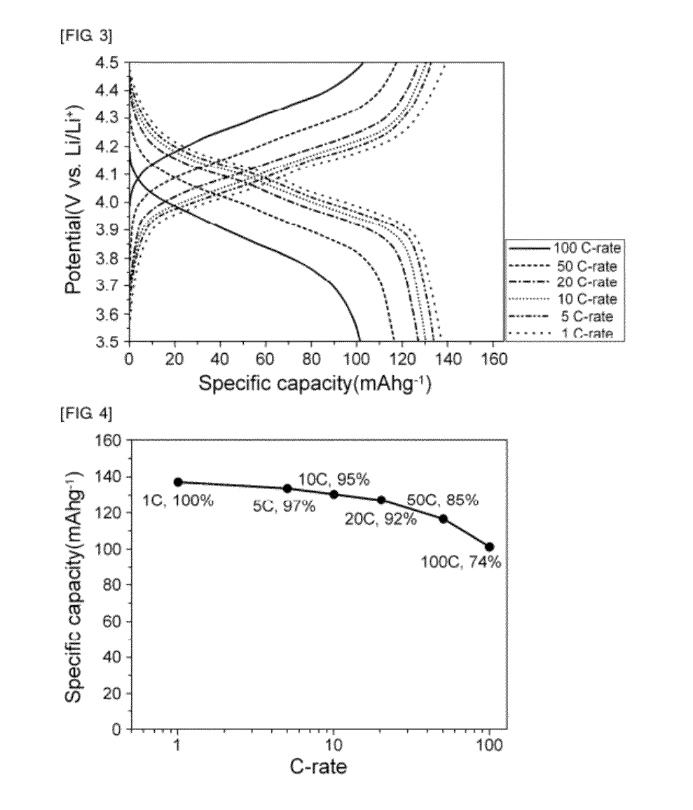

An energy storage device including an electrode prepared according to the second embodiment is manufactured, and characteristics thereof are evaluated. Evaluation results are shown in the following FIGS. 3 to 5.

The following FIG. 3 shows discharge curves at various C-rates of a lithium manganese oxide/graphene composite material in accordance with the second embodiment, and it is possible to check that FIG. 3 shows high specific capacitance (137 mAh/g at 1 C rate) and voltage drop variation is remarkably small even at a high C-rate value.

FIG. 4 is a graph showing C-rate dependence of specific capacitance of the lithium manganese oxide/graphene composite material in accordance with the second embodiment, and it is possible to check that high rate charge and discharge characteristics are remarkably excellent as 92% at 20 C rate and 85% at 50 C rate.

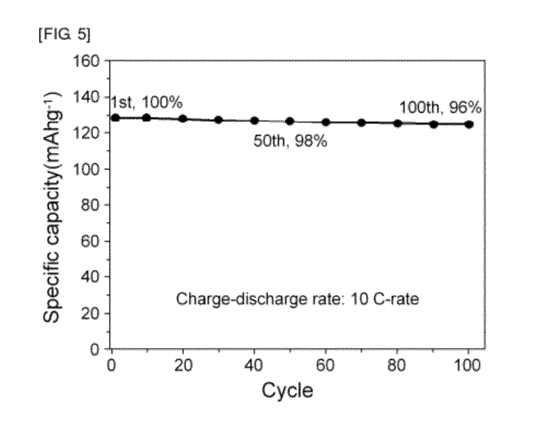

FIG. 5 is a graph showing life characteristics of the lithium manganese oxide/graphene composite material in accordance with the second embodiment, and it is checked that evaluation results of the life characteristics are also excellent.

According to the present invention, it is possible to prepare a nanocomposite material in which a lithium-containing metal oxide with high crystallinity is coated on a surface of graphene in the form of nanoparticles with a size of several nanometers.

Therefore, the nanocomposite material, in which the nano-sized lithium-containing metal oxide with high crystallinity is combined with the graphene with high specific surface area and high electrical conductivity, has an effect of achieving excellent high efficiency charge and discharge characteristics of energy storage devices such as an ultra-high capacity capacitor with high power and high energy density and a lithium secondary battery with high energy density.

What is claimed is:

1. A nanocomposite material comprising:
graphene; and
a lithium-containing metal oxide on a surface of the graphene.

2. The nanocomposite material according to claim 1, wherein the graphene has a plate shape formed by sp2 bonds of carbon atoms and a thickness of 0.34 to 4.0 nm.

3. The nanocomposite material according to claim 1, wherein the graphene has a two-dimensional electron conduction path.

4. The nanocomposite material according to claim 1, wherein the lithium-containing metal oxide is represented as the following formula 1.
LixMyOz Formula 1
wherein M is at least one metal selected from the group consisting of manganese, nickel, magnesium, cobalt, and copper, x is 0.01 to 4.0, y is 0.9 to 5.0, and z is 1.9 to 12.0.

5. The nanocomposite material according to claim 1, wherein the lithium-containing metal oxide on the surface of the graphene has a size less than 100 nm.

6. The nanocomposite material according to claim 1, wherein the nanocomposite material has a three-dimensional structure in which the lithium-containing metal oxide is laminated on the graphene.

7. A method for preparing a nanocomposite material comprising:
preparing a metal oxide/graphene precursor by reaction of a metal oxide and graphene; and
forming a lithium-containing metal oxide on a surface of the graphene by reaction of the metal oxide/graphene precursor and a lithium ion solution.

8. The method for preparing a nanocomposite material according to claim 7, wherein the metal oxide in the metal oxide/graphene precursor is maintained in a metal ion state by hydrolysis reaction.

9. The method for preparing a nanocomposite material according to claim 8, wherein the hydrolyzed metal ion is reduced to the lithium-containing metal oxide from the lithium ion solution and deposited on the surface of the graphene.

10. The method for preparing a nanocomposite material according to claim 7, wherein the metal oxide comprises at least one metal selected from the group consisting of manganese, nickel, magnesium, cobalt, and copper.

11. The method for preparing a nanocomposite material according to claim 7, wherein the graphene may be in the form of powder or aqueous dispersion.

12. The method for preparing a nanocomposite material according to claim 7, the metal oxide/graphene precursor is prepared at 20 to 400° C.

13. The method for preparing a nanocomposite material according to claim 7, wherein the metal oxide and the graphene react at a weight ratio of 1:99 to 99:1.

14. The method for preparing a nanocomposite material according to claim 7, wherein the lithium ion is a monovalent lithium ion.

15. The method for preparing a nanocomposite material according to claim 7, wherein the lithium ion solution is at least one selected from the group consisting of hydrates, nitrides, chlorides, and oxides containing lithium ions.

16. The method for preparing a nanocomposite material according to claim 7, wherein the lithium-containing metal oxide is formed on the surface of the graphene at 20 to 500° C.

17. The method for preparing a nanocomposite material according to claim 7, wherein the lithium-containing metal oxide is formed on the surface of the graphene by a microwave hydrothermal reactor.

18. An energy storage device comprising a nanocomposite material according to claim 1 as an electrode material.
